(19) United States
(12) Patent Application Publication
(10) Pub. No.: US 2013/0106098 A1
(43) Pub. Date: May 2, 2013

(54) CONNECTOR APPARATUS FOR BIDET WAND

(71) Applicant: Shanghai Kohler Electronics, Ltd., Shanghai (CN)

(72) Inventors: Baian Xie, Shanghai (CN); Qifeng Kuang, Shanghai (CN)

(73) Assignee: Shanghai Kohler Electronics, Ltd., Shanghai (CN)

(21) Appl. No.: 13/664,250

(22) Filed: Oct. 30, 2012

(30) Foreign Application Priority Data
Oct. 31, 2011 (CN) 201120424881.1

(51) Int. Cl. F16L 39/00

(52) U.S. Cl. 285/120.1

(57) ABSTRACT

A bidet wand for a toilet includes a nozzle, one or more inlet hoses, and a connector assembly configured to fluidly couple the nozzle to the one or more inlet hoses. The connector assembly includes one or more connector tubes, and first, second, and third members. Each connector tube is associated with one of the inlet hoses. The first, second, and third members are coupled to each other in axial alignment with each connector tube extending through the first member and the second member. Each inlet hose extends at least partially through the third member and is coupled to an inlet end of one of the connector tubes. The nozzle is configured to receive an outlet of each connector tube and at least a portion of the connector assembly therein.

### CROSS-REFERENCE TO RELATED PATENT APPLICATIONS

The present application claims priority to and the benefit of China P.R. Priority Application 201120424881.1, filed Oct. 31, 2011, the entire disclosure of which is hereby incorporated by reference in its entirety.

### BACKGROUND

The present disclosure is directed to a jet pipe apparatus, or connector device or apparatus, (e.g., for a bidet wand, spray wand, sprayer, etc.) used in plumbing fixture products (e.g., a toilet) to clean special parts of human body, as well as to a toilet or toilet seat having a spray wand.

In cleaning toilets having conventional jet pipe apparatuses, a plurality of connection pipes is typically used to connect a plurality of water paths (e.g., between a water source and a spray nozzle. Some connection pipes are conventionally coupled to a fixing seat by means of ultrasonic welding. For example, FIG. 1 illustrates a conventional fixing seat 110 and connection pipes 120 prior to the ultrasonic welding, and FIG. 2 illustrates the conventional fixing seat 110 and connection pipes 120 after ultrasonic welding.

More particularly, FIG. 1 and FIG. 2 illustrate three connection pipes 120. As shown in FIG. 1, two connection pipes 120a, 120b are coupled to (e.g., formed integrally with) the fixing seat 110. The other connection pipe 120c comprises a tongue on the pipe wall, and the fixing seat 110 includes an inner wall having a channel that corresponds to the connection pipe 120c and the further includes a groove corresponding to the tongue of the connection pipe 120c. During the manufacturing, the tongue on the connection pipe is positioned inside the groove of the fixing seat to thereby allow an end of the connection pipe 120c to be positioned inside the channel of the fixing seat 110. Subsequently, ultrasonic welding is conducted to couple the connection pipe 120c to the fixing seat (e.g., form the state of the integral formation of the connection pipes 120a-120c and the fixing seat 110), as shown in FIG. 2.

When the connection pipe (e.g., 120c) and the fixing seat 110 are coupled to each other (e.g., integrally formed) by means of ultrasonic welding, as described above, molding to required design standards may be difficult. The welding process may result in scars and cracks, distortion and deformation, material overflow and rough edges, and other difficulty in meeting size tolerances.

### SUMMARY

A bidet wand for a toilet includes a nozzle, one or more inlet hoses, and a connector assembly configured to fluidly couple the nozzle to the one or more inlet hoses. The connector assembly includes one or more connector tubes, and first, second, and third members. Each connector tube is associated with one of the inlet hoses. The first, second, and third members are coupled to each other in generally axial alignment with each connector tube extending through the first member and the second member. Each inlet hose extends at least partially through the third member and is coupled to an inlet end of one of the connector tubes. The nozzle is configured to receive an outlet of each connector tube and at least a portion of the connector assembly therein.

A bidet wand includes a nozzle, a plurality of inlet hoses, and a connector device that couples the nozzle to the inlet hoses in fluidic communication. The connector device includes a plurality of connector tubes, a first member, a second member, and a third member. Each connector tube is associated with one of the inlet hoses. The first member includes a plurality of through holes, each through hole having one of the connector tubes extending therethrough. The second member includes a plurality of through holes, each through hole being aligned with one of the through holes of the first member and having one of the connector tubes extending therethrough. The third member has one of the inlets hoses extending at least partially therethrough The first member, second member, and third member are coupled to each other in generally axial alignment. An inlet end of each connector tube is connected in fluidic communication with one of the inlet hoses to form a water flow channel. The nozzle is connected to the connector assembly with an outlet end of each connector tube being received within the nozzle.

### BRIEF DESCRIPTION OF THE DRAWINGS

FIG. 1 is a perspective view of a conventional fixing seat and connection pipes prior to assembly and ultrasonic welding;

FIG. 2 is a perspective view of the conventional fixing seat and the connection pipes in FIG. 1 after assembly and ultrasonic welding;

FIG. 3 is a perspective view of a jet pipe installed on an intelligent toilet seat without a nozzle installed, according an exemplary embodiment;

FIGS. 4a-4d are alternative perspective views of the toilet seat shown in FIG. 3;

FIG. 5 is a perspective view of a jet pipe installed on an intelligent toilet seat with a nozzle, according to an exemplary embodiment;

FIG. 6 is a perspective view of a jet pipe, according to an exemplary embodiment;

FIG. 7 is an exploded view the jet pipe shown in FIG. 6;

FIG. 8a is a front, plan view of a front fixing member, according to an exemplary embodiment;

FIG. 8b is a rear, plan view of the front fixing member shown in FIG. 8a;

FIG. 8c is a three-dimensional view of the front fixing member shown in FIG. 8a;

FIG. 9a is a front, plan view of a rear fixing member, according to an exemplary embodiment;

FIG. 9b is a rear, plan view of the rear fixing member shown in FIG. 9a;

FIG. 9c is a three-dimensional view of the rear fixing member shown in FIG. 9a;

FIG. 10a is a rear, plan view of a fixing seat, according to an exemplary embodiment;

FIG. 10b is a rear, plan view of the fixing seat shown in FIG. 10a;

FIG. 10c is a three-dimensional view of the fixing seat shown in FIG. 10a;

FIG. 11 is a longitudinal sectional view of the jet pipe shown in FIG. 6.

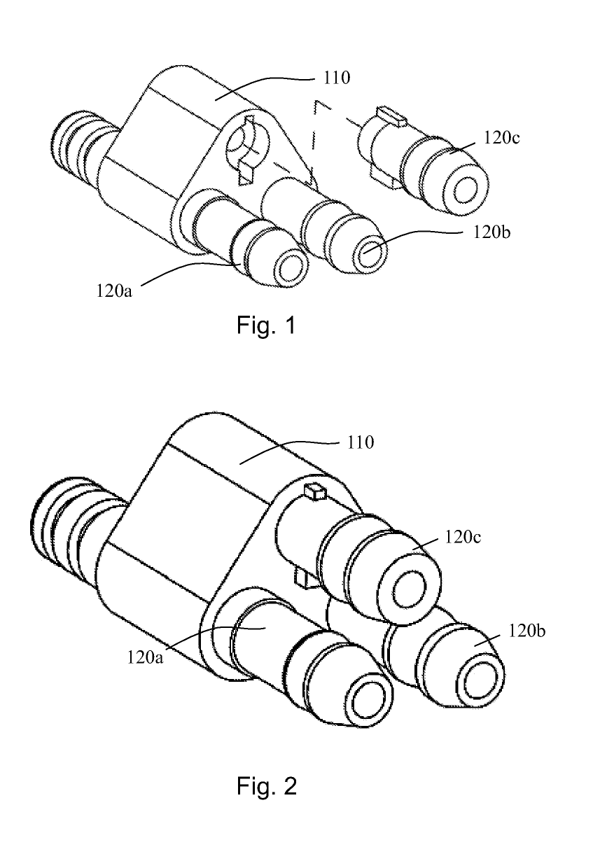

### DETAILED DESCRIPTION

To address the above technical problems, the present disclosure provides a new jet pipe apparatus for use in sanitary products (e.g., toilets, toilet seats, etc.). The jet pipe apparatus of varying embodiments can provide for easier mold stripping, can provide a simple and stable structure, can simplify the production, and can avoid the ultrasonic welding.

According to an exemplary embodiment, a jet pipe apparatus includes a jet pipe and a nozzle that is connected to an outlet end of the jet pipe by means of a socket (e.g., male/female relationship), wherein the jet pipe includes a plurality of connection pipes that are molded separately, a front fixing member, a rear fixing member, and a fixing seat. A plurality of inlet hoses are inserted into the side of the fixing seat that is far away from the nozzle (i.e., generally opposite the nozzle), while the other side thereof are coupled, and arranged sequentially, the rear fixing member and the front fixing member in the axial direction. A plurality of through holes are formed on the front fixing member and the rear fixing member, respectively, the plurality of connection pipes axially run or extend through the through holes on the front fixing member, the through holes on the rear fixing member, and the through hole or holes on the fixing seat, respectively, to be connected with the inlet hoses by means of a socket (i.e., male/female relationship), respectively, thereby forming water flow channels. The connection pipes are mutually coupled with the front fixing member, the rear fixing member, and the fixing seat.

According to an exemplary embodiment, a plurality of small holes are formed on the front fixing member and the rear fixing member, respectively, a plurality of bolt poles, with corresponding bolt holes, are formed on the fixing seat. A plurality of bolts run through the small holes on the front fixing member and the rear fixing member and are tightened into the bolt holes of the bolt poles on the fixing seat, thereby mutually fixing the front fixing member, the rear fixing member, and the fixing seat.

According to an exemplary embodiment, the socket connection between each of the connection pipes and the inlet hoses is fixed with a clamp. According to an exemplary embodiment, a sealing ring is fitted onto the outlet end of each of the connection pipe. A groove may also be formed on the outlet end of the connection pipe, and the sealing ring is inserted into the groove. According to an exemplary embodiment, one or more notches are formed at the through hole of the front fixing member, one or more ribs are formed on the connection pipe, and the rib of the connection pipe fits into a corresponding notch of the front fixing member.

According to an exemplary embodiment, one or more notches are formed at the through hole of the rear fixing member, one or more ribs are formed on the connection pipe, and the rib of the connection pipe fits into a corresponding notch of the rear fixing member. According to an exemplary embodiment, ribs are formed on a front half or portion of the base of the fixing seat, and correspondingly, there are corresponding grooves inside the nozzle socket for engagement therewith. According to an exemplary embodiment, a rear half or portion of the base of the fixing seat is locked and fixed with the nozzle socket via a locking device. According to an exemplary embodiment, a toilet or toilet seat includes the above jet pipe apparatus installed at the edge of the toilet close to the stool.

The jet pipe apparatus and the toilet or seat according to the various exemplary embodiments described herein achieve free flow in the pipes by means of mechanical connection and fixation, rather than by ultrasonic welding that is typically used in the prior art, thereby avoiding numerous drawbacks as a result of the ultrasonic welding. Moreover, two fixing members are used in the jet pipe apparatus to fix the connection pipes such that the fixation of the pipes is more stable and the water flow is less impeded than in a conventional jet pipe apparatus.

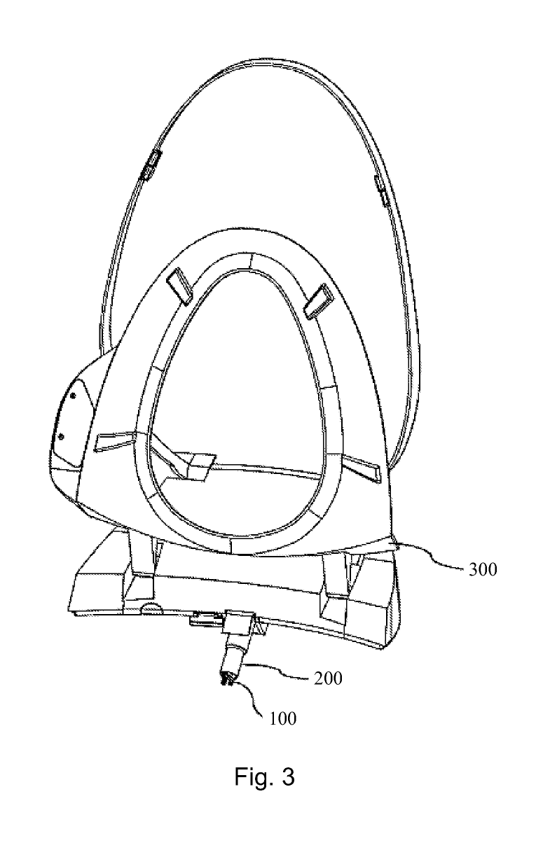

In the description and the figures, like reference numerals represent the like components. FIG. 3 illustrates a spray wand or jet pipe 200 installed on an intelligent toilet or toilet seat 300 without a nozzle having been installed on the jet pipe 200. As shown in FIG. 3, the jet pipe 200 is installed at the edge of the toilet or seat 300 close to the stool, and a plurality of connection pipes 100 extend from the jet pipe 200 toward the stool.

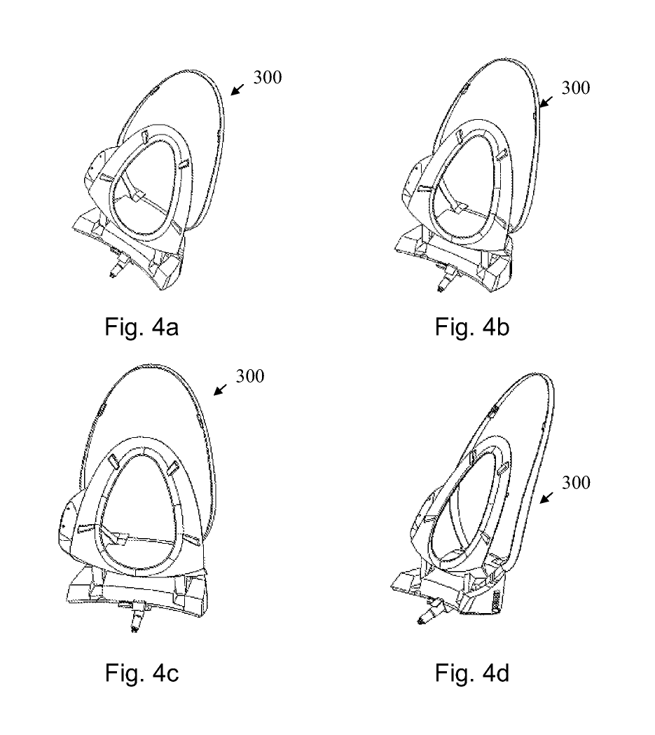

FIGS. 4a-4d depict the toilet or toilet seat 300 from different perspectives to further illustrate the installation relationship between the connection pipes (e.g., connector tubes) 100, the jet pipe 200, and the toilet or seat 300 (a nozzle is not depicted).

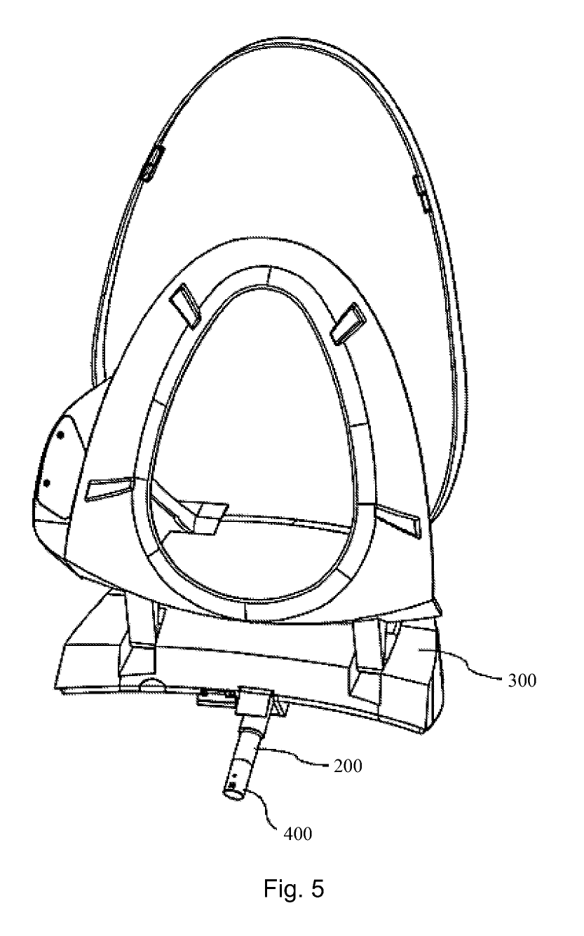

FIG. 5 illustrates the jet pipe 200 that installed on an intelligent toilet or seat 300, as shown previously shown in FIGS. 3 and 4a-4d, which includes a nozzle 400 installed through socket connection. As shown in FIG. 5, the connection pipes 100 are not visible, since the nozzle 400 has been connected to the jet pipe 200 through socket connection (i.e., the connection pipes 100 are received within the nozzle 400 in a male/female relationship).

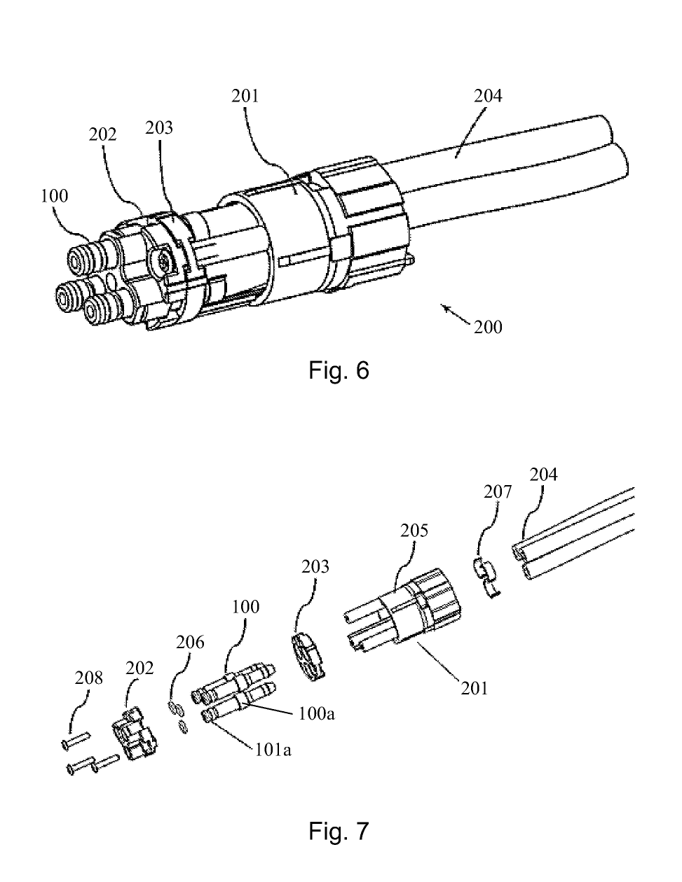

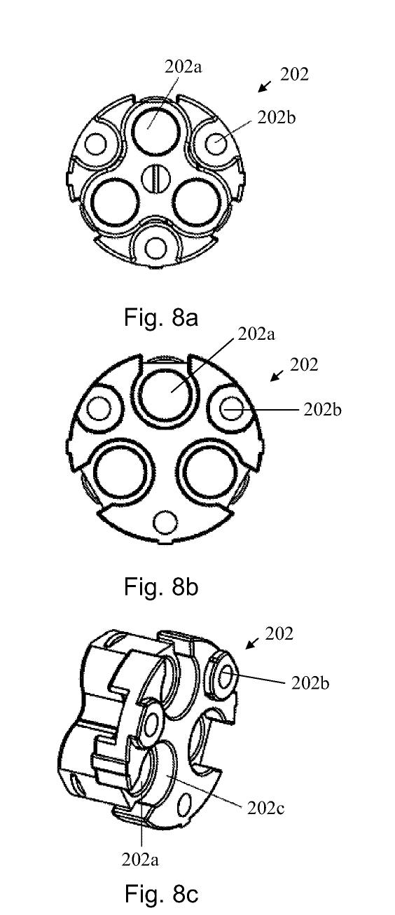

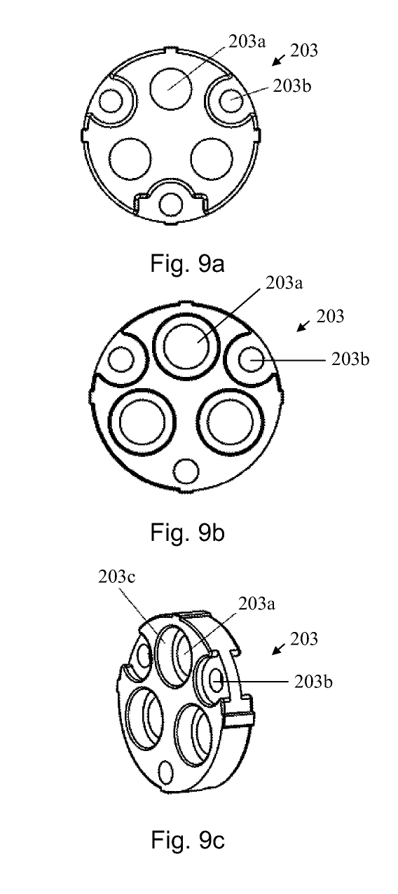

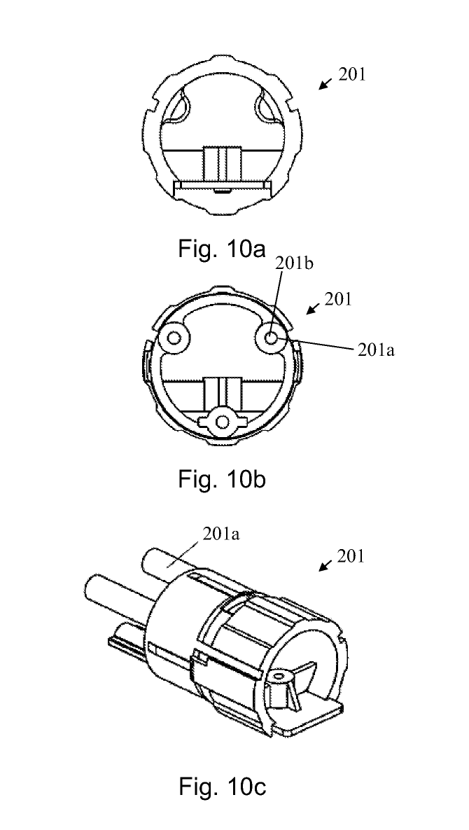

FIGS. 6, 7, and 11 illustrate the internal structure of the jet pipe 200 with a completed internal assembly according to an exemplary embodiment. As shown in FIG. 6, the jet pipe 200 comprises a plurality of connection pipes 100, a front fixing member 202 (further shown in FIGS. 8a-8c), a rear fixing member 203 (further shown in FIGS. 9a-9c), and a fixing seat or member 201 (further shown in FIGS. 10a-10c). A plurality of hoses 204 are inserted into one side of the fixing seat 201, while the other side thereof is sequentially provided with the rear fixing member 203 and the front fixing member 202 in the axial direction. The plurality of connection pipes 100 runs through the front fixing member 202 and the rear fixing member 203 to be inserted into the fixing seat 201, respectively, and thereby connect to the plurality of hoses 204.

It should be noted that although three connection pipes 100 are shown in FIG. 6 and these three connection pipes 100 are distributed evenly in the circumferential direction, those skilled in the art should understand that other amounts of connection pipes may be provided according to other exemplary embodiments (e.g., depending on the actual situation or application), and the relative positions between the connection pipes may also be adjusted according to other exemplary embodiments (e.g., depending the actual situation or application). These connection pipes 100 are independently disposed for easy mold stripping.

FIG. 7 is an exploded view of the jet pipe shown in FIG. 6. The connection pipes 100 sequentially run through a plurality of through holes 202a, 203a formed, respectively, on the front fixing member 202 and the rear fixing member 203. The connection pipes 100 then extend into a single or multiple through holes on the base 205 for socket connection with the ends of the hoses 204 (i.e., the hoses 204 receive the connection pipes 100 therein in a male/female relationship), which extend into the base 205 opposite the connection pipes 100 (i.e., the hoses 204 are inserted from the other side of the base 205). In such a way, sealed and free-flowing water channels are formed between the connection pipes 100 and the hoses 204. According to an exemplary embodiment, when the connection pipes 100 connect with the hoses 204 by means of a socket, a clamp 207 may also be used for fixation to prevent the hoses 204 and connection pipes 100 from separating apart and to further enhance the sealing between the connection pipes 100 and the hoses 204.

A plurality of small holes 202b, 203b, respectively, may be further formed on the front fixing member 202 and the rear fixing member 203 for bolts, screws, or other fasteners to extend through, while the fixing seat 201 includes a plurality of corresponding bolt poles 201a having bolt holes or apertures 201b therein. A plurality of bolts or other threaded fasteners 208 run through the small holes 202b on the front fixing member 202 and the small holes 203b on the rear fixing member 203, and are inserted into the corresponding bolt holes 201b in the bolt poles 201a on the fixing seat 201, thereby mutually fixing or coupling the front fixing member 202, the connection pipes 100, the rear fixing member 203, and the base 205.

The bolts 208, which are used for fixation between the above parts, may also effectively prevent the misalignment among these parts and, thereby, prevent interference of the flowing water in the flow channels. According to other exemplary embodiments, the fixation or coupling between the above parts does not have to be by means of bolts, so long as the fixation can ensure the prevention of interference with the flowing water in the flow channels. For example, the above parts may be locked, respectively, such that they are closely fixed together without causing misalignment.

Moreover, it should be understood that although three bolts 208 are shown in FIG. 7, other amounts of the bolts 208 may be used to couple the parts.

According to an exemplary embodiment, a sealing ring 206 may be fitted onto the outlet end of the connection pipe 100 (i.e., to engage the nozzle 400) to prevent the water flow from the connection pipe 100 from flowing back from outside of the connection pipe 100 to the hose 204. A groove (e.g., annular groove) 101a may be formed on the outlet end of the connection pipe 100 for more readily securing the sealing ring 206 to the connecting pipe 100.

FIG. 8a and FIG. 8b are front and the rear views, respectively, of the front fixing member 202 according to an exemplary embodiment, while FIG. 8c is a perspective view of the front fixing member 202 shown in FIGS. 8a and 8b.

As shown in FIG. 8a and FIG. 8b, a plurality of through holes 202a run through the front fixing member 202 and are configured insertion of the connection pipes 100 therein. Moreover, a plurality of small holes 202b run through the front fixing member 202 for insertion of the fixation bolts (e.g., 208).

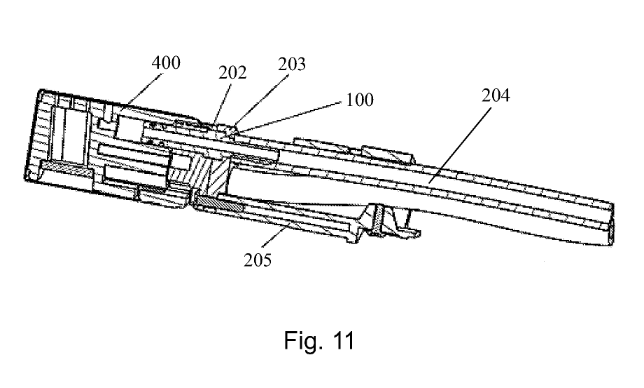

As shown in FIG. 8c, one or more notches 202c (e.g., a recess concentric with the through hole 202a) are formed at the through hole 202a of the front fixing member 202, which are configured to receive one or more ribs or annular or outwardly extending protrusions 100a formed on the connection pipe 100 (see, e.g., FIGS. 7 and 11). The rib 100a fits into the corresponding notch 202c such that the connection between the connection pipe 100 and the front fixing member 202 is closer. For example, the ribs 100a engage the notches 202c, so as to prevent the connection pipes 100 from moving entirely through the through holes 202a (i.e., the notches 202c and ribs 100a are cooperatively configured to prevent continued forward axial movement of the connection pipes 100 relative to the front fixing member 202).

FIG. 9a and FIG. 9b are the front and rear views, respectively, of the rear fixing member 203 according to an exemplary embodiment, while FIG. 9c is a perspective view of the rear fixing member 203 in shown in FIGS. 9a-9b.

As shown in FIG. 9a and FIG. 9b, a plurality of through holes 203a run through the rear fixing member 203 and are configured insertion of the connection pipes 100 therein. Moreover, a plurality of small holes 203b run through the rear fixing member 203 for insertion of the fixation bolts (e.g., 208).

As shown in FIG. 9c, one or more notches 203c (e.g., a recess concentric with the through hole 203a) are formed at the through hole 203a of the rear fixing member 203, which are configured to receive the one or more ribs 100a of the connection pipe 100. The rib 100a fits into the corresponding notch 203c such that the connection between the connection pipe 100 and the rear fixing member 203 is closer. For example, the ribs 100a engage the notches 203c, so as to prevent the connection pipes 100 from moving entirely through the through holes 203a (i.e., the notches 203c and ribs 100a are cooperatively configured to prevent continued rearward axial movement of the connection pipes 100 relative to the rear fixing member 203). As shown in the cross-sectional view of FIG. 11, when the rear fixing member 203 is coupled to the front fixing member 202, the ribs or protrusions 100a of the connecting pipes 100 are positioned and/or held between the notches 202c, 203c of the front and rear fixing members 202, 203 to hold the connecting pipes 100 in a generally fixed position.

FIG. 10a and FIG. 10b are front and rear views, respectively, of the fixing seat 201 according to an exemplary embodiment, while FIG. 10c is a perspective view of the fixing seat 201 shown in FIGS. 10a-10b.

As shown in FIG. 10c, a plurality of bolt poles 201a are formed on the side of the fixing seat 201 that is far away (i.e., generally opposite) from the hoses 204. Bolts 208 sequentially extend through the small holes 202b on the front fixing member 202, the small holes 203b on the rear fixing member 203, and are then tightened into the holes or apertures 201b in the bolt poles 201a, thereby mutually fixing or coupling the front fixing member 202, the rear fixing member 203, and the fixing seat 201.

According to an exemplary embodiment, ribs are formed on a front portion of the base 205 (i.e., opposite the hoses 204), which correspond to grooves inside a socket of the nozzle 400 for engagement therewith. The ribs enter the nozzle socket during installation for easy positioning. Moreover, a rearward portion of the base 205 is locked and fixed with the nozzle socket via a locking device.

FIG. 11 is a longitudinal sectional view illustrating the installation relationship between all parts of the jet pipe apparatus 200 according to an exemplary embodiment. FIG. 11 illustrates the relative positions of various parts of the jet pipe apparatus, as described above, such as the relative positions of the nozzle 400, the front fixing member 202, the rear fixing member 203, and the fixing seat 201.

What is claimed is:

1. A bidet wand for a toilet comprising:
a nozzle;
one or more inlet hoses; and
a connector assembly configured to fluidly couple the nozzle to the one or more inlet hoses;
wherein the connector assembly comprises:
one or more connector tubes, each connector tube being associated with one of the inlet hoses; and
first, second, and third members coupled to each other in generally axial alignment, each connector tube extending through the first member and the second member;
wherein each inlet hose extends at least partially through the third member and is coupled to an inlet end of one of the connector tubes; and
wherein the nozzle is configured to receive an outlet end of each connector tube and at least a portion of the connector assembly therein.

2. The bidet wand of claim 1, wherein each of the connector pipes is held in a generally fixed position relative to the connector assembly.

3. The bidet wand of claim 2, wherein each of the connector pipes includes an outwardly extending protrusion that is held in a generally fixed positioned between the first member and the second member.

4. The bidet wand of claim 1, wherein the first member includes one or more through holes, and the second member includes one or more through holes, the through holes of the first member being generally aligned with the through holes of the second member; and
wherein each connector pipe extends through one of the through holes of the first member and the aligned through hole of the second member.

5. The bidet wand of claim 4, wherein each through hole of the first member is associated with only one connector pipe.

6. The bidet wand of claim 4, wherein the first member includes one or more recesses, each recess being concentric with one of the through holes of the first member; and
wherein each of the connecting pipes includes an annular rib that is positioned in one of the recesses of the first member.

7. The bidet wand of claim 6, wherein the second member includes one or more recesses, each recess being concentric with one of the through holes of the second member; and
wherein the annular rib of each connecting pipe is positioned in one of the recesses of the first member.

8. The bidet wand of claim 1, wherein the first member includes one or more apertures, and the second member includes one or more apertures, each aperture of the first member being generally aligned with one of the apertures of the second member;
wherein the third member includes one or more axial extensions, each axial extension including an aperture and being generally aligned with one of the apertures of the first member; and
wherein a threaded fastener is received through one of the apertures of the first member, the aligned aperture of the second member, and the aligned aperture of the extension of the third member so as to couple the first member, the second member, and the third member.

9. The bidet wand of claim 1, wherein the inlet end of each of the connector tubes is received within the inlet hose, so as to couple each connector tube to one of the inlet hoses.

10. The bidet wand of claim 10, wherein the connector assembly further comprises one or more clamps, each clamp coupling one of the inlet hoses to one of the connector tubes.

11. The bidet wand of claim 1, wherein each connector tube further comprises a sealing ring coupled to the outlet end thereof.

12. The bidet wand of claim 11, wherein each connector tube includes an annular groove at the outlet end thereof, and one of the seal rings is at least partially received within the groove.

13. The bidet wand of claim 1, wherein a base portion of the third member is configured to receive the nozzle thereon, and the base portion includes one or more ribs configured to be received within one or more corresponding grooves of the nozzle.

14. The bidet wand of claim 1, wherein a base portion of the third member is configured to positively engage the nozzle, so as to couple the third member to the nozzle.

15. The bidet wand of claim 14, wherein the third member is locked to the nozzle.

16. A toilet comprising the bidet wand of claim 1.

17. A bidet wand comprising:
a nozzle;
a plurality of inlet hoses; and
a connector device that couples the nozzle to the inlet hoses in fluidic communication;
wherein the connector device comprises:
a plurality of connector tubes, each connector tube associated with one of the inlet hoses;
a first member having a plurality of through holes, each through hole having one of the connector tubes extending therethrough;
a second member having a plurality of through holes, each through hole being aligned with one of the through holes of the first member and having one of the connector tubes extending therethrough; and
a third member having one of the inlet hoses extend at least partially therethrough;
wherein the first member, second member, and third member are coupled to each other in generally axial alignment;
an inlet end of each connector tube is connected in fluidic communication with one of the inlet hoses to form a water flow channel; and
the nozzle is connected to the connector assembly, an outlet end of each connector tube being received within the nozzle.

18. The bidet wand of claim 17, wherein each through hole of the first member includes a recess adjacent thereto, each inlet tube includes an annular projection that is received within the recess associated with one of the through holes, and each annular projection is held between the first member and the second member so as to fixedly couple each connector tube to the connector assembly.

19. The bidet wand of claim 17, wherein the third member includes a plurality of axial extensions having an aperture;
wherein the first member includes a plurality of apertures, each aperture aligned with one of the axial extensions of the first member;
wherein the second member includes a plurality apertures, each aperture aligned with one of the axial extensions of the first member; and
wherein a plurality of threaded fasteners couple the first member, the second member, and the third member, each threaded fastener being received by an aperture of the third member, the aligned aperture of the second member, and the aligned aperture of the third member.
